(19) United States
(12) Patent Application Publication
(10) Pub. No.: US 2011/0103624 A1
(43) Pub. Date: May 5, 2011

(54) Systems and Methods for Providing Directional Audio in a Video Teleconference Meeting

(76) Inventor: Bran Ferren, Glendale, CA (US)

(21) Appl. No.: 12/611,550

(22) Filed: Nov. 3, 2009

(51) Int. Cl. H04R 5/02; H04N 7/15

(52) U.S. Cl. 381/306; 348/14.08; 348/E07.083

(57) ABSTRACT

Systems and methods are provided for providing directional audio in a video teleconference meeting. In one embodiment, a system is provided for providing directional audio in a video teleconference meeting. The system comprises a display formed of an acoustically transparent imaging surface and a plurality of speakers positioned about the display. The system further comprises a teleconference processor configured to receive video images of remote participants and audio data associated with sounds of the remote participants over a communication medium, display each participant about the display and provide audio data associated with a given participant to one or more speakers located close to or coincident with the displayed image of the respective remote participant.

### TECHNICAL FIELD

The present invention relates generally to video teleconferencing, and more particularly to systems and methods for providing directional audio in a video teleconferencing meeting.

### BACKGROUND

Video teleconference systems (VTCs) are used to connect meeting participants from one or more remote sites. It has been found through experience that effectiveness of the meeting increases with the illusion that the participants are in the same room. A desirable goal is to foster the illusion that all participants are in one room. However, the great majority of existing video conferencing systems do not provide meaningful directional audio. In many systems, the audio signals obtained from one or more microphones at a remote site are simply merged into a single audio feed and rendered at the local site by one or more arbitrarily positioned speakers. Therefore, spatial characteristics of the audio sounds provided at the local site bears little or no resemblance to the spatial distribution of the sound sources (i.e. participants) at the remote site. The lack of meaningful directional audio in current video conferencing systems significantly diminishes the quality of the illusion that all participants are in one room. At minimum, the lack of directional audio is a missed opportunity to provide the local participants with additional context and cueing for the conversational dynamics of the remote site.

### SUMMARY

In accordance with an aspect of the present invention, a system is provided for providing directional audio in a video teleconference meeting. The system comprises a display formed of an acoustically transparent imaging surface and a plurality of speakers positioned about the display. The system further comprises a teleconference processor configured to receive video images of remote participants and audio data associated with sounds of the remote participants over a communication medium, display each participant about the display and provide audio data associated with a given participant to one or more speakers of the plurality of speakers located close to or coincident with the displayed image of the respective remote participant.

In accordance with yet another aspect of the present invention, a system is provided for providing directional audio in a video teleconference meeting. The system comprises a first video teleconference system comprising a camera for capturing video image data of the remote participants, a plurality of microphones for capturing sound from the remote participants, and a first teleconference processor configured to transmit video and audio data over a communication medium. The system further comprises a second video teleconference system comprising a display formed of an acoustically transparent imaging surface, a plurality of speakers positioned about the display and a second teleconference processor configured to receive video images of remote participants and audio data associated with sounds of the remote participants from the first video teleconference system over the communication medium, display each participant about the display and provide audio data associated with a given participant to one or more speakers of the plurality of speakers located close to or coincident with the displayed image of the respective remote participant.

In accordance with yet a further aspect of the present invention, a method is provided for providing directional audio in a video teleconference meeting. The method comprises capturing sound and video of participants at a remote site, analyzing audio inputs to determine audio control information, aggregating the video data, the audio data and audio control information and transmitting the aggregated data over a communication medium. The method further comprises separating the aggregated data received over the communication medium at a local site into video image data, audio data and audio control information, displaying video image data of participants on an acoustically transparent imaging surface and routing the audio data associated with a respective participant to one or more speakers located about the acoustically transparent imaging surface and close to or coincident with displayed images of the respective participants based on the audio control information.

### BRIEF DESCRIPTION OF THE DRAWINGS

FIG. 1 illustrates a block diagram of a system for providing directional audio acoustic imaging in a video teleconference meeting in accordance with an aspect of the present invention.

FIG. 2 illustrates a block diagram of exemplary components of a remote video teleconferencing system in accordance with an aspect of the present invention.

FIG. 3 illustrates a block diagram of exemplary components of a local video teleconferencing system in accordance with an aspect of the present invention.

FIG. 4 illustrates a view of participants located at a remote site employing a remote video teleconferencing system as illustrated in FIG. 1 or FIG. 2 in accordance with an aspect of the present invention.

FIG. 5 illustrates a participant view of a local video teleconferencing system with displayed video images of the three participants of FIG. 4 in accordance with an aspect of the present invention.

FIG. 6 illustrates a method for providing directional audio acoustic imaging in a video teleconference meeting in accordance with an aspect of the present invention.

### DETAILED DESCRIPTION

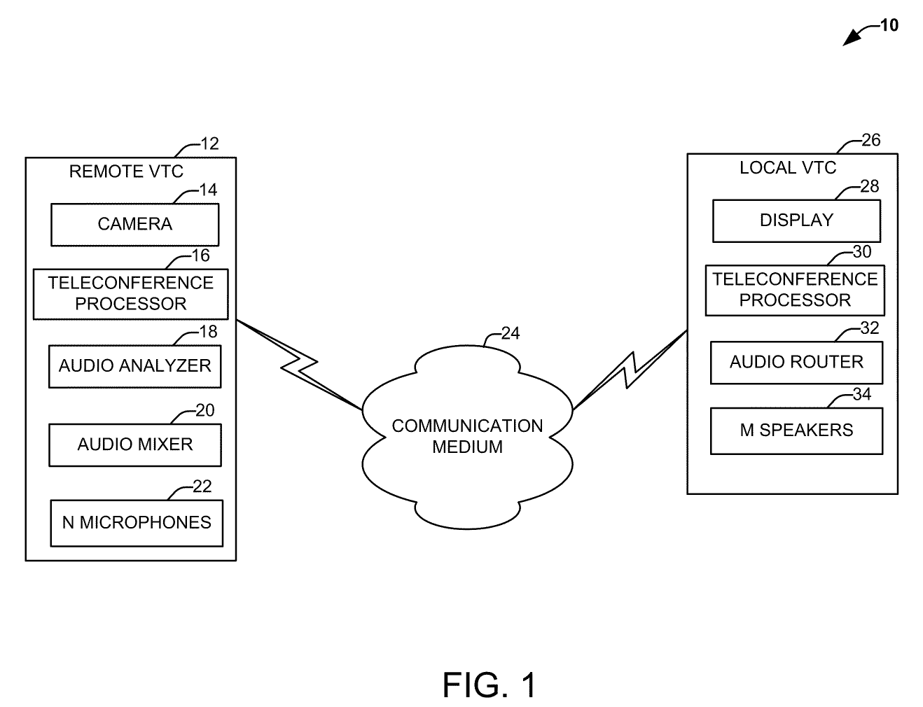

FIG. 1 illustrates a system 10 for providing directional audio acoustic imaging in a video teleconference meeting in accordance with an aspect of the present invention. The system 10 includes a remote video teleconference system 12 coupled to a local video teleconference system 26 through a communication medium 24. The communication medium 24 can be a local-area or wide-area network (wired or wireless), or a mixture of such mechanisms, which provides one or more communication mechanisms (e.g., paths and protocols) to pass data and/or control between software video teleconferencing systems. The remote video teleconference system 12 is located at a remote site and includes a camera 14 for capturing images of participants at the remote location and a first teleconference processor 16 for processing audio data, video image data and audio control information and providing an interface to the communication medium 24. The remote video teleconferencing system 12 also includes N microphones 22 for capturing audio of the participants at the remote location, where N is an integer greater than one. The remote video teleconferencing system 12 includes an audio analyzer 18 that analyzes the audio data produced by sounds of the participants and produces audio control information based on the audio data. The audio analyzer 18 can be a separate component or integrated into the computing system. The remote video teleconference system 12 can also includes an audio mixer 20 that channelizes audio data for transmission across the communication medium 24. The audio mixer 20 can be a separate component or integrated into the teleconference processor 16 or the audio analyzer 18.

The local video teleconference system 26 includes a display 28 for displaying images of participants from the remote location at the local location and a second teleconference processor 30 for processing audio data, video image data and audio control information and providing an interface to the communication medium 24. The display 28 is formed from an acoustically transparent imaging surface. The first teleconference processor 16 and the second teleconference processor 30 can be an analog processor and components, a computer processor or a computer network processor as one or more integrated circuits or circuit boards containing one or more microprocessors. An acoustically transparent imaging surface can be provided by a technique of perforating a screen at a small enough scale that holes are not visible based on a given size screen and/or viewing distance to a given size screen. The local video teleconferencing system 26 also includes M speakers 34 for playing the sounds of the participants from the remote location at the local site, where M is an integer greater than one that can be equal or not equal to N. Speakers 34 are placed about the display 28 formed from the acoustically transparent imaging surface, close to or coincident with the video images of the remote participants. The speakers 34 can be placed behind and above the display 28, in back of display 28 or in front of display 28, for example, on or in a table in which the display 28 is disposed. The local video teleconferencing system 26 also includes an audio router 32 that routes the audio data to respective speakers located close to or coincident with displayed images of the participants, based on audio control information received from the remote video teleconference system 12.

The audio router 32 or the computing system 30 can be configured to dechannelize the audio data prior to routing of the audio data to the respective speakers located behind and close to or coincident with the associated respective video images. Images of the videoconference participants from the remote site are projected onto the display 28 formed of the acoustically transparent imaging surface at the local site as audio is routed to the speakers 34 such that as a particular remote participant is speaking, audio is provided from the speaker close to or coincident with the local image of the speaking participant.

In one aspect of the invention, a microphone (preferably a lapel microphone) is provided to each participant at the remote site. Audio from the microphone is routed directly to corresponding speakers at the local site, for example, via audio control information (e.g., indication of acoustic imaging assignments) based on audio directional information provided by the audio analyzer 18. This can accomplished by knowing the location of the microphone that captures sounds associated with the audio data or the direction of the sounds associated with the audio data. This approach does require a separate audio channel for each microphone/speaker pair. Audio obtained from other microphones (overhead boom and/or group microphones, for example) may be mixed and presented through all speakers equally.

In another aspect of the invention, one or more audio channels obtained at the remote site are merged together by the audio mixer 20 prior to transmission to the local site, and a separate data channel provided by the audio analyzer 18 provides audio control information to the audio router 32 at the local site. The data channel can provide an indication of acoustic imaging assignments as well as an indication of a dominant participant. The audio router 32 can ensure that, at any given time, audio is presented primarily from the speaker close to or coincident with the image of the dominant participant. As a great majority of conference dialogue is dominated by a single speaker, the determination of the dominant participant may be made through a simple analysis of the audio levels obtained by the microphones at the remote site by the audio analyzer 18.

In those instances in which a determination cannot be made with a high degree of certainty, more sophisticated directional audio techniques may be used. For example, the audio analyzer 18 at the remote site may perform a time of flight calculation to estimate, based on the time of arrival at the various microphones 22 arrayed at the remote site, a dominant direction from which the audio emanates. This directional information is transmitted to the local site, where the relative speaker volume levels are adjusted to replicate the audio distribution at the local site. This approach may be useful for those times in a conference when two or more participants are speaking simultaneously.

In yet another aspect of the invention, an intermediate number (more than one but less than the number of microphones) of audio channels is employed. For example, consider a six participant system, in which the audio acquired by six microphones at the remote location is rendered by six speakers at the local site. Here, more than one but less than six, for example, three, audio channels can be provided. It is to be appreciated that the reduction in the number of channels reduces the bandwidth of the video teleconferencing system which is highly desirable while still preserving the directionality of the present invention. If less than three of the microphones are active, each audio signal is passed in a separate audio channel by the audio mixer 20, and routed to one of the six speakers according to routing information provided in the data channel. The audio mixer is configured to channelize the audio data into less channels than the available microphones which reduces bandwidth while audio directionality of the local video teleconference system 26 can be preserved by providing control information to the local video teleconference system 26. If more than three microphones are active, the audio signals are merged into the three available audio channels. The merge may be uniform or pair-wise.

In a uniform merge, all audio signals are merged into a single signal by the audio mixer 20 and passed through one or more of the three audio channels. The audio signal is then rendered by all of the speakers 34 at the local site. In pair-wise merging, two or more audio signals from physically adjacent microphones 22 are merged by the audio mixer 20 until less than three signals remain. These three signals are passed through the three audio channels. Channels carrying an audio signal from a single microphone are rendered at the corresponding speaker. Signals carrying a signal composed from signals from more than one microphone are rendered at the corresponding more than one speaker. It is to be appreciated that the remote video teleconferencing system 12 could also includes components of the local video conferencing system 26 and the local video teleconferencing system 26 could also include components of the remote video conferencing system 12.

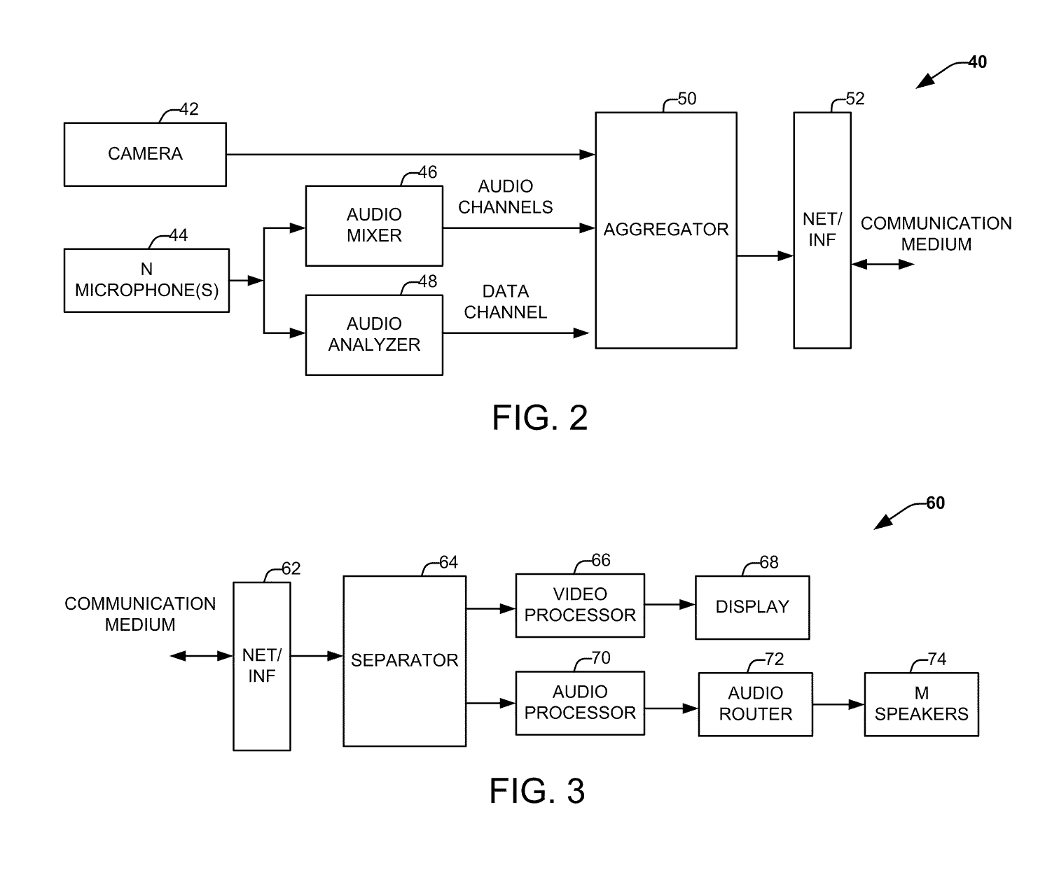

FIG. 2 illustrates a block diagram of exemplary components of a remote video teleconferencing system 40 in accordance with an aspect of the present invention. The remote video teleconferencing system 40 includes N microphones 44 that captures sounds from participants and converts the sounds to audio data and a camera 32 that captures video image data of the participants located at a remote site. The audio data is provided to an audio mixer 46 and an audio analyzer 48. The audio mixer 48 channelizes the audio data provided by the N microphones into the same number or less number of audio channels to be transmitted to a local video teleconferencing system.

The audio analyzer 46 analyzes the audio data to provide audio control information over a data channel, which could include a dominant participant. The audio data provided in the audio channels, the audio control information provided over the data channel and the video image data of the participants are provided to an aggregator 50 that aggregates the audio data, direction control data and video image data of the participants and provides it to a network interface 52.

FIG. 3 illustrates a block diagram of exemplary components of a local video teleconferencing system 60 in accordance with an aspect of the present invention. The local video teleconferencing system 60 includes a network interface 62 that receives aggregated audio data, audio control information and video image data of the participants from a remote video teleconferencing system and provides this data to a separator 64. The separator 64 separates the audio data and audio control information and video image data of the participants and provides the audio data and audio control information to an audio processor 70 and the video image data of the participants to a video processor 66. The audio processor 70 and video processor 66 may be synchronized to synchronize audio and video data of displayed participants.

The video processor 66 is configured to process the video image data of participants from the remote video teleconferencing system and display each participant about an acoustically transparent display surface 68 with one or more speakers of M speakers 74 being close to or coincident with a respective participant. The audio processor 70 receives the audio data and directional control information. The audio processor 70 dechannelizes the audio data, and provides the audio data to the audio router 72 for routing to speakers 74 close to or coincident with respective participant's video image based on the audio control information. The audio processor 70 can also adjust the volume of the speakers 74 for a dominant participant as the video processor 66 displays the participant images on the acoustically transparent display surface 68.

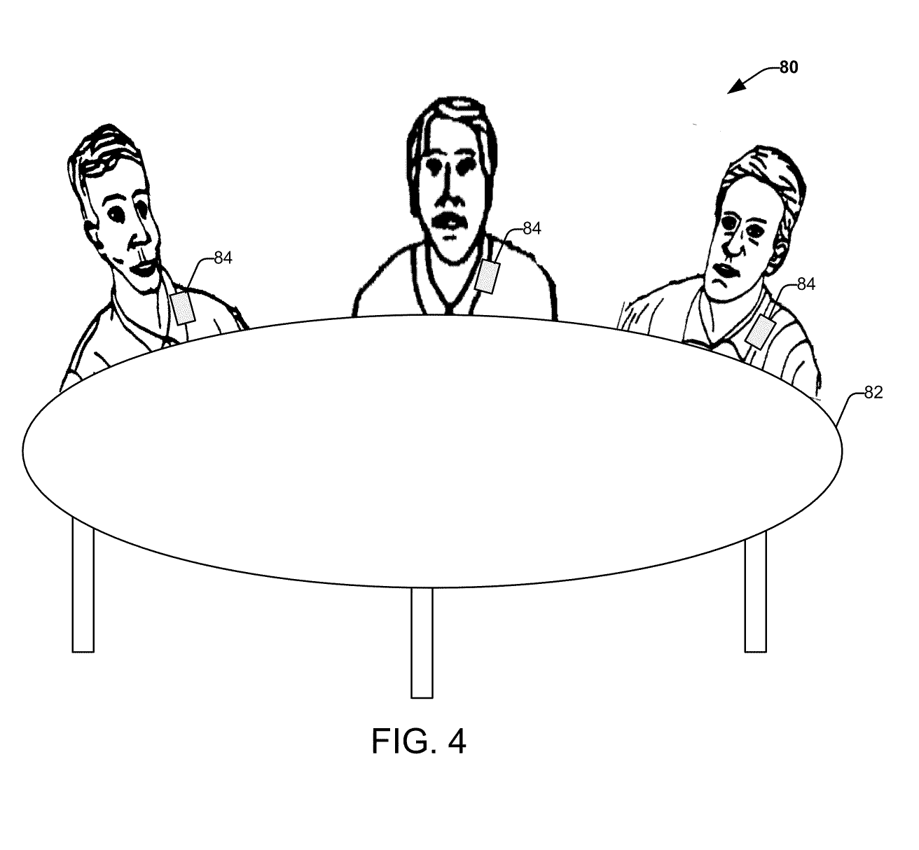

FIG. 4 illustrates a view 80 of participants located at a remote site employing a remote video teleconferencing system as illustrated in FIG. 1 or FIG. 2 in accordance with an aspect of the present invention. In the example of FIG. 4, three participants are spaced around a round table 82 with each participant having a microphone 84 attached to their respective collars for capturing sound from each participant. A camera (not shown) captures video images of the participants. The video image data, audio data and audio control information are transmitted over a communication medium to a local site employing a local video teleconferencing system.

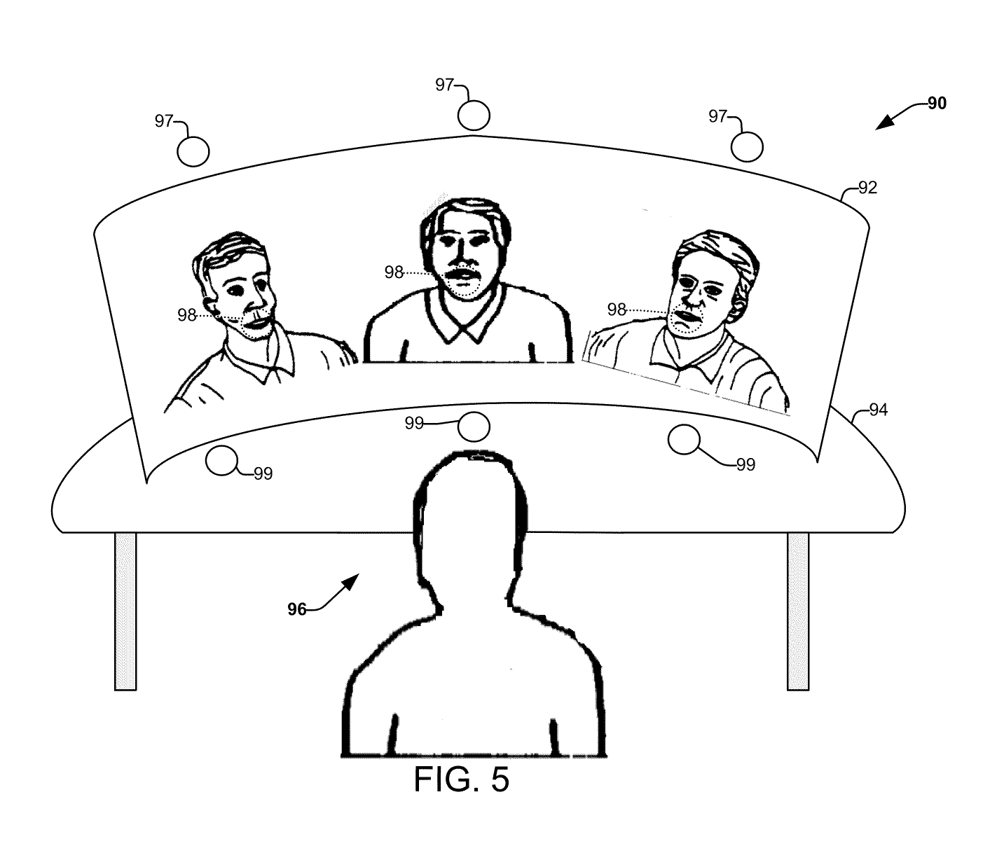

FIG. 5 illustrates a participant view of a local video teleconferencing system with displayed video images of the three participants of FIG. 4 in accordance with an aspect of the present invention. A participant 96 is positioned in front of a curved display surface 92 formed of an acoustically transparent imaging surface residing on a semi-circular table 94. The three participants from remote video teleconferencing systems are displayed equally spaced about the curved display surface each having dedicated speakers 98 residing close to and behind the image of a respective participant, such that as a particular remote participant is speaking, audio is provided from the speakers 98 close to or coincident with the local image of the speaking participant. However, if the display is rear projected, the speakers cannot be mounted behind the display without shadowing the display. In this case, speakers 97 may be mounted above the display over each displayed participant, or speakers 99 may be mounted in a strip below the display, or embedded in the table and angled to reflect from the display. Directionality is maintained, since human hearing, while able to precisely locate sound horizontally, is poor at precisely locating the vertical origin of a sound. Volume may be adjusted if it is determined that one of the participants is a dominant participant or the audio control information provides different volumes for different participants.

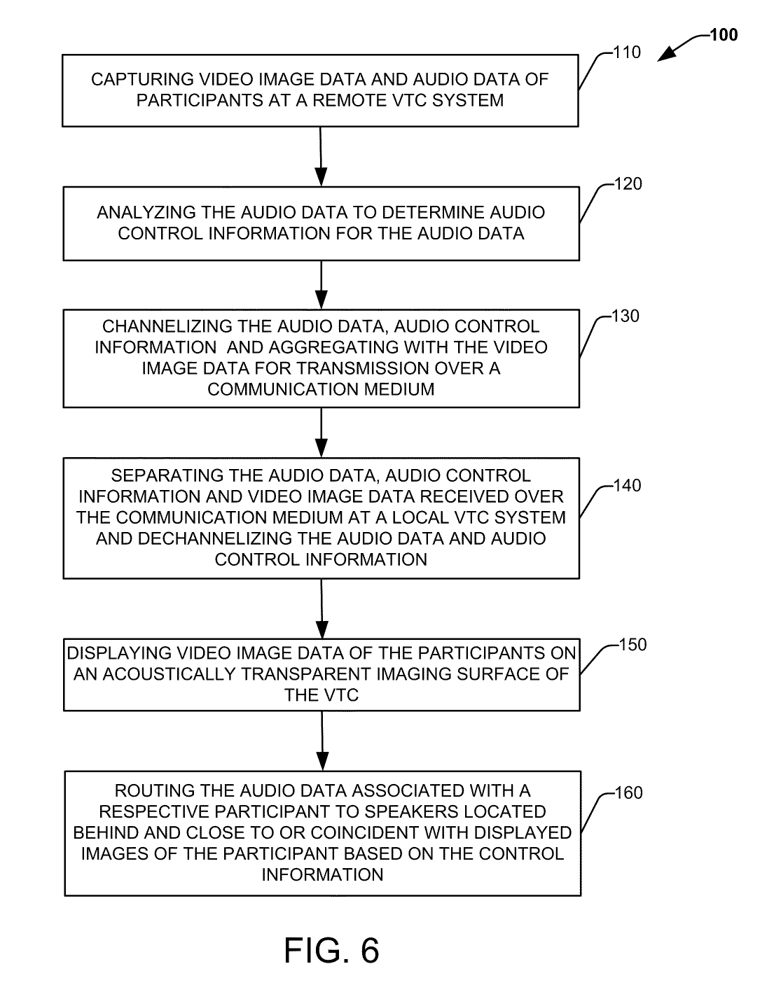

In view of the foregoing structural and functional features described above, a method will be better appreciated with reference to FIG. 6. It is to be understood and appreciated that the illustrated actions, in other embodiments, may occur in different orders and/or concurrently with other actions. Moreover, not all illustrated features may be required to implement a method. It is to be further understood that the following method can be implemented in hardware (e.g., a computer or a computer network as one or more integrated circuits or circuit boards containing one or more microprocessors, and/or analog audio and video processors), software (e.g., as executable instructions running on one or more processors of a computer system), or any combination thereof.

FIG. 6 illustrates a methodology 100 for providing directional audio in a video teleconference meeting in accordance with an aspect of the present invention. The method begins at 110 where video image data and audio data of participants is captured at a remote video teleconference system. At 120, the audio data is analyzed to determine audio control information, such as which voices are associated with which video image data of a respective participant and whether one of the respective participants is a dominant participant. At 130, the audio data and audio control information is channelized and aggregated with the video image data for transmission over a communication medium. At 140, the audio data, the audio control information and the video image data received over the communication medium at a local video teleconference system is separated and the audio data and audio control information is dechannelized. At 150, video images of the participants are displayed on an acoustically transparent imaging surface of the local video teleconference system. At 160, audio data associated with respective participants is routed to speakers located close to or coincident with displayed images of the participants based on the audio control information. The speaker volume may be increased behind one of the participants if the audio control information indicates that there is a dominant participant or the adjusted for more than one participant if the audio control information provides different volumes for different participants.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the scope of the appended claims.

Having described the invention, the following is claimed:

1. A system for providing directional audio in a video teleconference meeting, the system comprising:
a display formed of an acoustically transparent imaging surface;
a plurality of speakers positioned in the vicinity of the display; and
a teleconference processor configured to receive video images of remote participants and audio data associated with sounds of the remote participants over a communication medium, display each participant about the display and provide audio data associated with a given participant to one or more speakers of the plurality of speakers located close to or coincident with the displayed image of the respective remote participant.

2. The system of claim 1, further comprising an audio router configured to route the audio data to speakers based on audio control information received with the audio data.

3. The system of claim 2, wherein the audio control information includes an indicator of which participant is a dominant participant and the computing system being configured to increase the volume at the one or more speakers close to or coincident with the video image of the dominant participant.

4. The system of claim 1, further comprising a remote video teleconferencing system located at a remote site that includes a camera for capturing video image data of the remote participants and a plurality of microphones for capturing audio data associated with sounds of the remote participants and a teleconference processor configured to transmit the video image data and audio data over the communication medium.

5. The system of claim 4, the remote video teleconferencing system further comprising an audio analyzer for analyzing the audio data to determine directional information associated with sounds from the participants and providing audio control information to match the video image data displayed at the display with the audio data routed to the one or more speakers located close to or coincident with the displayed image of the respective remote participant.

6. The system of claim 5, wherein the audio analyzer is configured to determine a dominant participant and provide this information in the audio control information.

7. The system of claim 6, wherein the audio analyzer determines the dominant participant by one of analyzing audio levels received at the microphones and performing time of flight calculations.

8. The system of claim 4, wherein a microphone is provided to each participant and the audio data of each microphone is routed directly to corresponding speakers at the local site.

9. The system of claim 4, wherein the number of the plurality of microphones is not equal to the number of the plurality of speakers.

10. The system of claim 1, further comprising an audio mixer that channelizes the audio data from the plurality of microphones into a number of channels that is less than the number of the plurality of microphones.

11. A system for providing directional audio in a video teleconference meeting, the system comprising:
a first video teleconference system comprising:
a camera for capturing video image data of the remote participants;
a plurality of microphones for capturing audio data associated with sounds of the remote participants; and
a first teleconference processor configured to transmit the video image data and audio data over a communication medium; and
a second video teleconference system comprising:
a display formed of an acoustically transparent imaging surface;
a plurality of speakers positioned about a back of the display; and
a second teleconference processor configured to receive video images of remote participants and audio data associated with sounds of the remote participants from the first video teleconference system over the communication medium, display each participant about the display and provide audio data associated with a given participant to one or more speakers of the plurality of speakers located close to or coincident with the displayed image of the respective remote participant.

12. The system of claim 11, further comprising an audio router configured to route the audio data to speakers based on audio control information received with the audio data.

13. The system of claim 11, the first video teleconferencing system further comprising an audio analyzer for analyzing the audio data to determine directional information associated with sounds from the participants and providing audio control information to match the video image data displayed at the display with the audio data routed to the one or more speakers located close to or coincident with the displayed image of the respective remote participant.

14. The system of claim 13, wherein the audio analyzer is configured to determine a dominant participant and provide this information in the audio control information and the second computing system is configured to increase the volume at the one or more speakers close to or coincident with the video image of the dominant participant.

15. The system of claim 11, further comprising an audio mixer that channelizes the audio data from the plurality of microphones into a number of channels that is less than the number of the plurality of microphones and an audio analyzer that provides audio control information across a data channel for dechannelizing the channelized audio data.

16. A method for providing directional audio in a video teleconference meeting, the method comprising:
capturing video image data and audio data of participants at a remote site;
analyzing the audio data to determine audio control information of the audio data;
aggregating the video image data, the audio data and audio control information and transmitting the aggregated data over a communication medium;
separating the aggregated data received over the communication medium at a local site into video image data, audio data and audio control information;
displaying video image data of participants on an acoustically transparent imaging surface; and
routing the audio data associated with a respective participant to one or more speakers located behind the acoustically transparent imaging surface and close to or coincident with a displayed image of the respective participant based on the audio control information.

17. The method of claim 16, wherein the audio data is captured from a plurality of microphones and further comprising channelizing the audio data into a number of channels that is less than the number of the plurality of microphones for transmission over the communication medium and dechannelizing the channelized data at the local site based on the audio control information.

18. The method of claim 16, further comprising analyzing the audio data to determine a dominant participant and provide this information in the audio control information and increasing the volume at the one or more speakers close to or coincident with the video image of the dominant participant.

19. The method of claim 18, wherein the dominant participant is determined by one of analyzing audio levels received at the microphones and performing time of flight calculations.

20. The method of claim 16, wherein a microphone is provided to each participant for capturing audio data at the remote site and the audio data of each microphone is routed directly to corresponding one or more speakers at the local site.
